(19) United States
(12) Patent Application Publication
(10) Pub. No.: US 2024/0169293 A1
(43) Pub. Date: May 23, 2024

(54) PREDICTIVE ASSESSMENTS OF VENDOR RISK

(71) Applicant: Cyber GRX, Denver, CO (US)

(72) Inventors: Joshua Adam Gray, Oxford, MS (US); Aser Garcia, Stockbridge, GA (US); Daniel Tobin, Marysville, PA (US); Frank Price, Boulder, CO (US); Joseph Marques, Leesburg, VA (US)

(21) Appl. No.: 17/991,595

(22) Filed: Nov. 21, 2022

(51) Int. Cl. G06Q 10/0635

(52) U.S. Cl. CPC G06Q 10/0635

(57) ABSTRACT

Described techniques relate to improved methods, systems, devices, and apparatuses that support predictive assessments of vendor risk. The described techniques provide for machine learning and modeling to produce predictive risk profiles for vendors (e.g., even without security profile data provided by the vendor). Various described techniques may also produce unique insights across an entire portfolio of third parties using instant, predictive risk assessment results. Predictive risk profiles predict how a given vendor will answer each question in a standardized assessment based on one or more parameters (e.g., firmographics), both outside-in data and inside-out data, and similar completed assessments stored on an exchange associated with the system.

### FIELD OF TECHNOLOGY

The present disclosure relates generally to cyber security, and more specifically to predictive assessments of vendor risk.

### BACKGROUND

An entity or company may interact with one or more vendors. The entity may perform its own cyber security analysis. The entity may also benefit from information regarding cyber security practices, measures, and behaviors, for the one or more vendors. Without such information, poor security behaviors of the one or more vendors may impact the entity, or the entity may be unable to address or mitigate such behaviors.

### SUMMARY

The described techniques relate to improved methods, systems, devices, and apparatuses that support predictive assessments of vendor risk. Generally, the described techniques provide for machine learning and modeling to produce predictive risk profiles for vendors (e.g., even without security profile data provided by the vendor). Techniques described herein may also produce unique insights across an entire portfolio of third parties using instant, predictive risk assessment results. Predictive risk profiles predict how a given vendor will answer each question in a standardized assessment based on one or more parameters (e.g., firmographics), both outside-in data and inside-out data, and similar completed assessments stored on an exchange associated with the system.

A method for predictively assessing vendor risk is described. The method may include receiving, by one or more processors, one or more input parameter values for a cyber security questionnaire for a vendor, the one or more input parameter values comprising demographic data for the vendor, responsive input information for the cyber security questionnaire corresponding to at least a second vendor associated with the demographic data, rating information associated with the vendor, triggering event information associated with the vendor, or any combination thereof, generating, by the one or more processors, multiple sets of candidate response inputs for the cyber security questionnaire based at least in part on a machine learning model and the one or more input parameter values, determining, by the one or more processors for each of the multiple sets of candidate response inputs for the cyber security questionnaire, a respective set of risk score values, aggregating, by the one or more processors, each respective set of risk score values for each of the multiple sets of candidate response inputs for the cyber security questionnaire, producing, by the one or more processors, a set of predictive response outputs for the cyber security questionnaire based on a distribution of the aggregated set of risk score values for each of the multiple sets of candidate response inputs for the cyber security questionnaire, and outputting, by the one or more processors for display to a user via a graphical user interface on a user device, the set of predictive response outputs for the cyber security questionnaire.

An apparatus for predictively assessing vendor risk is described. The apparatus may include a processor, memory coupled with the processor, and instructions stored in the memory. The instructions may be executable by the processor to cause the apparatus to receive, by one or more processors, one or more input parameter values for a cyber security questionnaire for a vendor, the one or more input parameter values comprising demographic data for the vendor, responsive input information for the cyber security questionnaire corresponding to at least a second vendor associated with the demographic data, rating information associated with the vendor, triggering event information associated with the vendor, or any combination thereof, generate, by the one or more processors, multiple sets of candidate response inputs for the cyber security questionnaire based at least in part on a machine learning model and the one or more input parameter values, determine, by the one or more processors for each of the multiple sets of candidate response inputs for the cyber security questionnaire, a respective set of risk score values, aggregate, by the one or more processors, each respective set of risk score values for each of the multiple sets of candidate response inputs for the cyber security questionnaire, produce, by the one or more processors, a set of predictive response outputs for the cyber security questionnaire based on a distribution of the aggregated set of risk score values for each of the multiple sets of candidate response inputs for the cyber security questionnaire, and outputting, by the one or more processors for display to a user via a graphical user interface on a user device, the set of predictive response outputs for the cyber security questionnaire.

Another apparatus for predictively assessing vendor risk is described. The apparatus may include means for receiving, by one or more processors, one or more input parameter values for a cyber security questionnaire for a vendor, the one or more input parameter values comprising demographic data for the vendor, responsive input information for the cyber security questionnaire corresponding to at least a second vendor associated with the demographic data, rating information associated with the vendor, triggering event information associated with the vendor, or any combination thereof, means for generating, by the one or more processors, multiple sets of candidate response inputs for the cyber security questionnaire based at least in part on a machine learning model and the one or more input parameter values, means for determining, by the one or more processors for each of the multiple sets of candidate response inputs for the cyber security questionnaire, a respective set of risk score values, means for aggregating, by the one or more processors, each respective set of risk score values for each of the multiple sets of candidate response inputs for the cyber security questionnaire, means for producing, by the one or more processors, a set of predictive response outputs for the cyber security questionnaire based on a distribution of the aggregated set of risk score values for each of the multiple sets of candidate response inputs for the cyber security questionnaire, and means for outputting, by the one or more processors for display to a user via a graphical user interface on a user device, the set of predictive response outputs for the cyber security questionnaire.

A non-transitory computer-readable medium storing code for predictively assessing vendor risk is described. The code may include instructions executable by a processor to receive, by one or more processors, one or more input parameter values for a cyber security questionnaire for a vendor, the one or more input parameter values comprising demographic data for the vendor, responsive input information for the cyber security questionnaire corresponding to at least a second vendor associated with the demographic data, rating information associated with the vendor, triggering event information associated with the vendor, or any combination thereof, generate, by the one or more processors, multiple sets of candidate response inputs for the cyber security questionnaire based at least in part on a machine learning model and the one or more input parameter values, determine, by the one or more processors for each of the multiple sets of candidate response inputs for the cyber security questionnaire, a respective set of risk score values, aggregate, by the one or more processors, each respective set of risk score values for each of the multiple sets of candidate response inputs for the cyber security questionnaire, produce, by the one or more processors, a set of predictive response outputs for the cyber security questionnaire based on a distribution of the aggregated set of risk score values for each of the multiple sets of candidate response inputs for the cyber security questionnaire, and outputting, by the one or more processors for display to a user via a graphical user interface on a user device, the set of predictive response outputs for the cyber security questionnaire.

Some examples of the method, apparatuses, and non-transitory computer-readable medium described herein may further include operations, features, means, or instructions for calculating a set of confidence values for the set of predictive response outputs for the cyber security questionnaire.

Some examples of the method, apparatuses, and non-transitory computer-readable medium described herein may further include operations, features, means, or instructions for analyzing, by the one or more processors, the multiple sets of candidate response inputs for the cyber security questionnaire and identifying, by the one or more processors, one or more high-risk security behaviors for the vendor based at least in part on the analyzed set of candidate response inputs.

Some examples of the method, apparatuses, and non-transitory computer-readable medium described herein may further include operations, features, means, or instructions for calculating, by the one or more processors, a confidence value for the one or more high-risk security behaviors.

Some examples of the method, apparatuses, and non-transitory computer-readable medium described herein may further include operations, features, means, or instructions for outputting, by the one or more processors for display to the user via the graphical user interface on the user device, an indication of the one or more high-risk security behaviors, a confidence value for the one or more high-risk security behaviors, or both.

Some examples of the method, apparatuses, and non-transitory computer-readable medium described herein may further include operations, features, means, or instructions for generating, by the one or more processors, a set of questionnaire data for a plurality of vendors, the set of questionnaire data comprising response inputs for the cyber security questionnaire provided by the plurality of vendors and training the machine learning model based at least in part on the set of questionnaire data, wherein generating the multiple sets of candidate response inputs may be based at least in part on the training.

In some examples of the method, apparatuses, and non-transitory computer-readable medium described herein, training the machine learning model may include operations, features, means, or instructions for generating, by the one or more processors, a set of preliminary predictive response outputs for the cyber security questionnaire for a first subset of vendors of a plurality of vendors based at least in part on the machine learning model and according a first set of weight values corresponding to a set of input parameter values associated with the first subset of vendors, comparing, by the one or more processors, the set of preliminary predictive response outputs for the cyber security questionnaire for the first subset of vendors with at least a portion of the set of questionnaire data, and changing the first set of weight values to a second set of weight values based at least in part on the comparing.

Some examples of the method, apparatuses, and non-transitory computer-readable medium described herein may further include operations, features, means, or instructions for generating, by the one or more processors, a set of questionnaire data for a plurality of vendors, the set of questionnaire data comprising response inputs for the cyber security questionnaire provided by the plurality of vendors, wherein the one or more input parameter values may be based at least in part on the set of questionnaire data and adding the set of predictive response outputs for the cyber security questionnaire for the vendor to the set of questionnaire data.

In some examples of the method, apparatuses, and non-transitory computer-readable medium described herein, the demographic data for the vendor may include a geographical location of the vendor, a number of employees associated with the vendor, revenue information associated with the vendor, a type of the vendor, or any combination thereof. In some examples of the method, apparatuses, and non-transitory computer-readable medium described herein, the triggering event information for the vendor a failure to comply with one or more security standard protocols, a data breach, a failure to provide responsive inputs to the cyber security questionnaire, or any combination thereof.

### BRIEF DESCRIPTION OF THE DRAWINGS

FIG. 1 illustrates an example of a security prediction system that supports predictive assessments of vendor risk in accordance with aspects of the present disclosure.

FIG. 2 illustrates an example of a flow diagram that supports predictive assessments of vendor risk in accordance with aspects of the present disclosure.

FIG. 3 illustrates an example of a security report that supports predictive assessments of vendor risk in accordance with aspects of the present disclosure.

FIG. 4 illustrates an example of a security report that supports predictive assessments of vendor risk in accordance with aspects of the present disclosure.

FIG. 5 illustrates an example of a security report that supports predictive assessments of vendor risk in accordance with aspects of the present disclosure.

FIG. 6 illustrates an example of a security report that supports predictive assessments of vendor risk in accordance with aspects of the present disclosure.

FIG. 7 illustrates an example of a security report that supports predictive assessments of vendor risk in accordance with aspects of the present disclosure.

FIG. 8 shows a block diagram of an action response component that supports predictive assessments of vendor risk in accordance with aspects of the present disclosure.

FIG. 9 shows a diagram of a system including a device that supports predictive assessments of vendor risk in accordance with aspects of the present disclosure.

FIGS. 10 through 13 show flowcharts illustrating methods that support predictive assessments of vendor risk in accordance with aspects of the present disclosure.

### DETAILED DESCRIPTION

Various entities (e.g., a business entities) may own, originate, or have access to, sensitive information, which may include financial data, personal data, or any other information. Such data may be at risk to various cyber-attacks, security breaches, misfeasance, or malfeasance by bad actors, among other examples. Additionally, or alternatively, the business entity may interact with one or more third parties (e.g., vendors). Interactions with such third parties may result in access, by the third parties, to sensitive data owned or held by the business entity, or failed security measures resulting in breaches of security protocols by the business entity. It may therefore be beneficial for the business entity to perform some form of third-party cyber risk management, to ensure that vendors perform appropriate cyber security measures, to protect their own data, data owned or held by the business entity, or any combination thereof.

Third-party cyber risk management programs come in many varieties. In some examples, the business entity may generate a cyber security or risk management assessment (e.g., a security questionnaire). The business entity may provide the assessment to multiple vendors, and request that each vendor provide assessment data (e.g., responses to the circulated questionnaire). However, in some cases, the business entity may not be able to gain access to all risk assessment data requested. Additionally, or alternatively, the business entity 105 may have access to too much data (e.g., and may therefore be unable to effectively identify and mitigate risky behavior).

The described techniques utilize machine learning to produce possible answers to each question in a cyber security questionnaire for a given vendor, where each possible answer can be accompanied by a probability of likelihood based on one or more parameters (e.g., company demographics and data from cyber security risk triggers and/or ratings). This is then modeled off of an extensive exchange (e.g., a portfolio or database of completed security questionnaires from a variety of vendors across various parameters) and used to score those possible answers to produce results with confidence scores and output potential high risk practices that are not mitigated with their own corresponding confidence scores. Using the previously mentioned data categories, the model learns an internal representation between the input data and the questionnaire to output answers. Methods to provide predictions from a machine learning model are then used to produce possible assessments that are individually scored for risk levels. The scores are then aggregated to describe the distribution of risk for that score and the possible answers analyzed to produce the possible high-risk practices.

Aspects of the disclosure are initially described in the context of a predictively assessing vendor risk. Aspects of the disclosure are further illustrated by and described with reference to. Aspects of the disclosure are further illustrated by and described with reference to security prediction systems, flow diagrams, and security reports. Aspects of the disclosure are further illustrated by and described with reference to apparatus diagrams, system diagrams, and flowcharts that relate to predictive assessments of vendor risk.

This description provides examples, and is not intended to limit the scope, applicability or configuration of the principles described herein. Rather, the ensuing description will provide those skilled in the art with an enabling description for implementing various aspects of the principles described herein. As can be understood by one skilled in the art, various changes may be made in the function and arrangement of elements without departing from the application.

It should be appreciated by a person skilled in the art that one or more aspects of the disclosure may be implemented in a security system to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

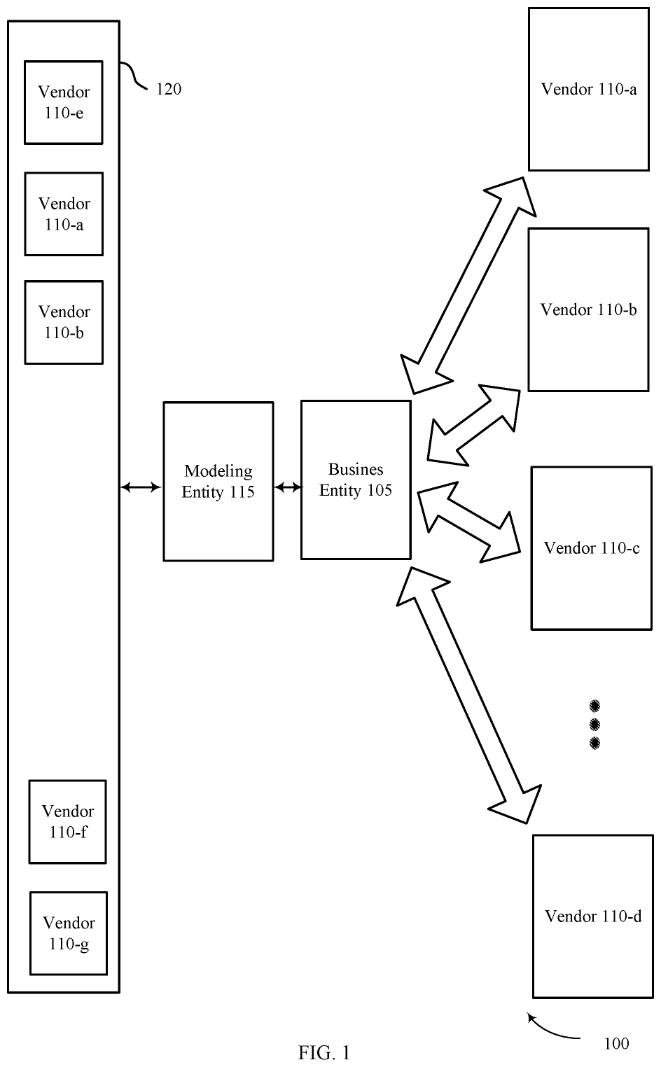

FIG. 1 illustrates an example of a security prediction system 100 that supports predictive assessments of vendor risk in accordance with aspects of the present disclosure. The security prediction system 100 may be implemented by one or more entities, according to techniques and systems described herein. For example, the modeling entity 115 may represent a system, device, apparatus, computer-readable medium, etc., as described herein. The modeling entity 115 may be in communication with or have access to an exchange 120, and may provide information to a user (e.g., via a graphical user interface (GUI)) to one or more users associated with the business entity 105.

Various entities (e.g., a business entity 105) may own, originate, or have access to, sensitive information, which may include financial data, personal data, or any other information. Such data may be at risk to various cyber risks. Additionally, or alternatively, the business entity 105 may interact with one or more third parties (e.g., vendors 110, such as vendor 110-a, vendor 110-b, vendor 110-c, and vendor 110-d). Interactions with such third parties may result in access, by the third parties, to sensitive data owned or held by the business entity 105. It may therefore be beneficial for the business entity to perform some form of third-party cyber risk management, to ensure that vendors 110 perform appropriate cyber security measures, to protect their own data, data owned or heled by the business entity 105, or any combination thereof.

Third-party cyber risk management programs come in many varieties. In some examples, the business entity 105 may generate a cyber security or risk management assessment (e.g., a security questionnaire). The business entity 105 may provide the assessment to multiple vendors (e.g., the vendor 110-a through the vendor 110-d), and request that each vendor provide assessment data (e.g., responses to the circulated questionnaire). However, in some cases, the business entity 105 may not be able to gain access to all risk assessment data requested. For instance, the vendor 110-a and the vendor 110-b may respond to the request to fill out the security questionnaire, but other vendors 110 (e.g., the vendor 110-c and the vendor 110-d) may fail to respond or refuse to respond to the request, resulting in insufficient security data and heightened risk for the business entity 105. In some examples, even if all vendors 110 respond, such responses may be delayed, resulting in risky behavior in the interim. For instance, vendor 110-d may engage in risky behaviors, as indicated in a filled out security questionnaire, but while delaying responding, such risky behaviors may adversely impact business entity 105. With quicker access to a security assessment for the vendor 110-d, the business entity 105 may be able to address such security concerns more quickly (e.g., or sever ties with vendor 110-d in favor of a vendor 110 that does not generate such heightened security risks). Additionally, or alternatively, the business entity 105 may have access to too much data (e.g., and may therefore be unable to effectively identify and mitigate risky behavior). When manually and individually collecting third-party assessments from each vendor 110 within a business ecosystem, data can pile up and often be unactionable due to its collection in static spreadsheets or the fact that there are multiple assessment types that cannot be analyzed easily (e.g., a risk assessment for vendor 110-a may be differently formatted, or include different content, than a risk assessment for vendor 110-b, resulting in ineffectual data analysis and risk mitigation).

Techniques described herein harnesses machine learning to produce predictive risk profiles. Techniques described herein may also produce unique insights across an entire portfolio of third parties using instant, predictive risk assessment results. Predictive risk profiles predict how a given vendor 110 will answer each question in a standardized assessment based on one or more parameters (e.g., firmographics), both outside-in data and inside-out data, and similar completed assessments on the exchange with a threshold accuracy rate (e.g., up to 85%).

Techniques described herein may include the practice of collecting, standardizing, and analyzing data in reference to third-party security practices and technology infrastructure, and the use of that information to assess and improve an organization's third-party risk posture. The business entity 105 may generate an exchange 120, which includes security information for multiple vendors (e.g., vendor 110-e, vendor 110-f, and vendor 110-g). The exchange 120 may include information for multiple third parties (e.g., hundreds of third parties, thousands of third partis, hundreds of thousands of third parties, etc.). In some examples, the business entity may ensure standardization of security information in the exchange 120 by collecting questionnaire answers that are similar, or identical, across multiple vendors 110. Standardization of collected security data may enable utilization of machine learning to perform analyses of the data (e.g., via modeling entity 115). For instance, the business entity 105 may generate an exchange 120 including data for multiple vendors 110 (e.g., thousands of completed self-attested assessments). The use of standardized data to power an information exchange of risk assessments may support advanced machine learning for a given data set, something that data sets derived from customized questionnaires cannot achieve.

The modeling entity 115 may use a machine learning algorithm to produce possible answers to each question in a cyber security questionnaire for a given vendor. For instance, the modeling entity 115 may train a data set from exchange 120 to effectively predict cyber security responses to the cyber security questionnaire. The modeling entity 115 may determine, for a given vendor 110 (e.g., that has not completed the questionnaire) a set of candidate responses to the questionnaire based on a learning model from the exchange 120. That is, the modeling entity 115 may input one or more parameters (e.g., based on the learning model and other vendors 110 having the same or similar parameters) for vendor 110-c, and may generate predicted responses to the security questionnaire. Each possible or candidate answer to the questionnaire for the vendor 110-c may be accompanied by a probability of likelihood based on the parameters (e.g., company demographics and data such as risk triggers, security ratings, among other examples). This is then modeled off of the exchange of data (e.g., the exchange 120), and used to score those possible answers to produce results with confidence scores. The modeling entity 115 may output potential high risk practices that are not mitigated with their own corresponding confidence scores.

The modeling entity 115 may build the model using the exchange 120. Using the parameters (e.g., data categories), the modeling entity 115 may learn an internal representation between the input data for a given vendor 110 and the questionnaire responses for that vendor 110 to output predictive answers. Methods to provide predictions from a machine learning model are then used to produce possible assessments that are individually scored for risk levels. The scores are then aggregated to describe the distribution of risk for that score and the possible answers analyzed to produce the possible high-risk practices. Periodically (e.g., quarterly, monthly, annually, among other examples), the modeling entity 115 may update the learning model based on predictions. For example, the exchange 120 may initially include security data for vendor 110-e, vendor 110-f, and vendor 110-g. If vendor 110-b fills out the questionnaire, then the modeling entity 115 may add the responses for vendor 110-b to the exchange 120. Additionally, or alternatively, the modeling entity 115 may generate predictive responses and corresponding confidence scores, risk scores and confidence scores for various behaviors for the vendor 110-a. Periodically, the modeling entity 115 may add the predictions for vendor 110-a to the portfolio (e.g., exchange) 120, and may retrain the model to improve its accuracy based on the additional data (e.g., additional questionnaire responses, and predictions performed for additional vendors 110). For example, the device may generate, by the one or more processors, a set of preliminary predictive response outputs for the cyber security questionnaire for a first subset of vendors of a plurality of vendors based at least in part on the machine learning model and according a first set of weight values corresponding to a set of input parameter values associated with the first subset of vendors. The device may compare the set of preliminary predictive response outputs for the cyber security questionnaire for the first subset of vendors with at least a portion of the set of questionnaire data, and change the first set of weight values to a second set of weight values based at least in part on the comparing.

Techniques described herein may provide unique insights across an entire exchange 120 of third parties. From inherent and residual risk views, to mapping against common and customized frameworks, to providing control gap analysis using threat profiles and attack analytics against real-life cyberattacks, techniques described herein may provide a comprehensive and actionable risk profile for multiple vendors, whether such vendors provide their own data or not. Techniques described herein may support transparency and collaboration to address control gaps and risk remediation strategies across an entire third-party portfolio.

The modeling entity 115 may provide risk analysis for any vendor 110 to the business entity 105. For example, the business entity 105 may monitor and assess their third-party cyber risk through any lens that matters most to them. While the insights within the provided risk profiles can be used to assess and monitor a number of things within risk management and security programs, the business entity 105 may utilize apply any use case to the predictive risk profiles to improve the use of the data available and assist in decision-making. For instance, the business entity 105 may request a risk assessment for vendor 110-c and vendor 110-d. The modeling entity 115 may, using various parameters for vendor 110-c and vendor 110-d, generate a predictive risk analysis for each vendor. This repeatable process may distinguish vendors requiring security due diligence from those that have no cyber relevance.

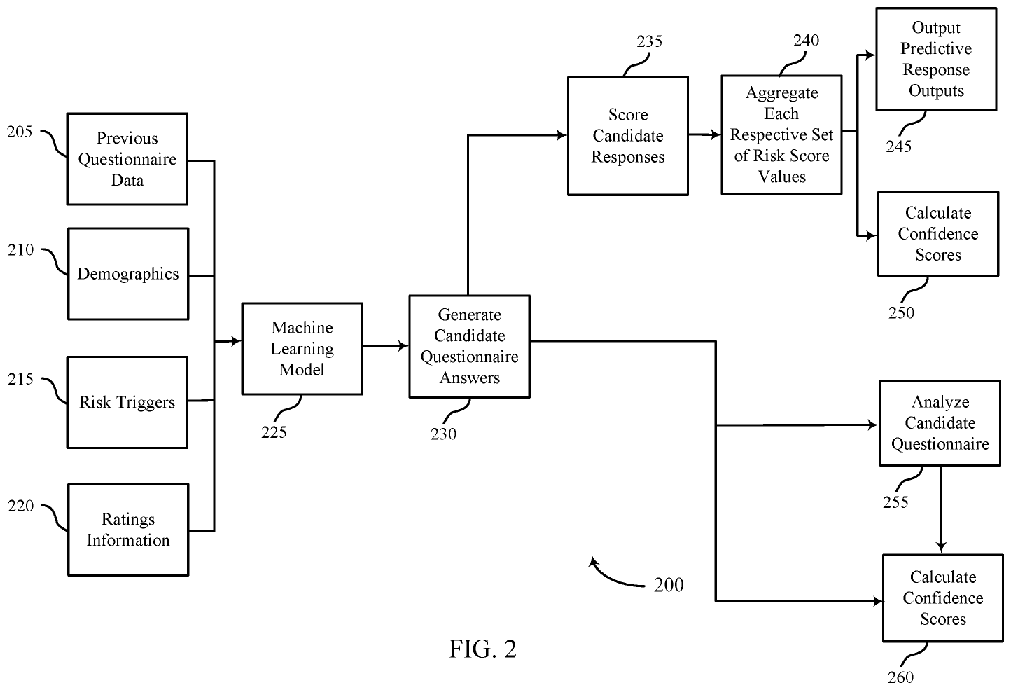

FIG. 2 that supports predictive assessments of vendor risk in accordance with aspects of the present disclosure. Flow diagram 200 may be implemented by a modeling entity 115, as described with reference to FIG. 1. The modeling entity 115 may include one or more servers, processors, memories, or any combination thereof. In some examples, the flow diagram 200 may be implemented by a device, which may be referred to as an apparatus and one or more processors, or a non-transitory computer-readable medium, storing code for predictively assessing vendor risk. The code may include instructions executable by the processors. The techniques described herein may be performed by such a device, which may be an example of the device 905, or by various disparate elements of a system (e.g., including processors, memory, a GUI, electronic communications between the various elements, etc.).

For example, the device may receive, by one or more processors, one or more input parameter values for a cyber security questionnaire for a vendor. The one or more input parameters may include previous questionnaire data 205 (e.g., for the vendor, or for another vendor having similar parameters), demographics 210 (e.g., demographic data for the vendor), ratings information 220 associated with the vendor (e.g., security ratings or security data provided by internal or external security evaluations, security certifications or awards, among other examples), triggering event information (e.g., risk triggers 215) associated with the vendor (e.g., one or more events that have previously or are currently occurring at the vendor, such as data breaches, security behaviors or violations of security norms or rules, client complaints, security updates, security update requests, among other examples), or any combination thereof.

The machine learning model 225 may be trained based on data within an exchange (e.g., an exchange 120). For example, a business entity 105 may successfully gathered many (e.g., 10,000) completed cyber security assessments from exchange participants or members. This data may be further cleaned and reduced to create a set (e.g., roughly over 1,000) of combined data points for training a model by the machine learning model 225. An 80/20 split may be used for creating the training and testing sets. The information in these assessments may be grouped covering strategic, operational, core, management, and privacy controls of an entity's (e.g., vendor's) cyber security program. The maturity level of each control family may also be considered through people, process, and technology. This information may be primarily binary information, with a value (e.g., 72) being ternary and another value (e.g., 35) being senary, confirming the existence of a cyber security control in place under the entity's program and may range upwards of 250 in total for some assessment levels. These controls may be the response variables of interest in a predictor-response machine learning model. Predictor variables may be selected from a collection of external datasets with the importance of leveraging entity parameters (e.g., firmographics) such as industry, revenue, size, age, and online popularity for maturity and selected controls. Cyber security information may be provided into the model through breach monitoring relating to leaked passwords, product vulnerabilities, policy violations, domain weaknesses, etc. This may be paired with numerical ratings for vulnerability severity such as web security, software patching, and email security collected through automated network scanning.

External data may be used as predictor variables in the model, such as industry, revenue, company size, age, online popularity, network scanning, and breach monitoring, among other examples. Each element may be considered to be a data type, such as a factor, integer, or float. Network scanning is a family of several variables that describe the security of a company at the domain accessible level. Breach monitoring is a family of several variables that are gathered from the dark web as well as breach signals and datasets.

From a modelling perspective, a modeling entity may consider each assessment control a random variable that will be observed once an entity has completed the cyber security assessment. The modeling may include modeling the joint probability distribution of assessment answers given predictor variables for an entity. Controls may be primarily variables with a binomial distribution over both outcomes, with few being multinomial over three outcomes, while the maturity questions may be multinomial over six outcomes. For illustration purposes, for 200 independent binary response variables, there are 2²⁰⁰−1, approximately 1.6·10⁶⁰ parameters to determine for the joint distribution. Along with the sheer number of parameters to fit, the physical limitations of storing the parameters in memory may also limit modelling purely off the joint distribution. Since cyber security controls tend to correlate with one another given the context of the question in the assessment, the modeling may reduce the complexity of fitting a large number of parameters by leveraging conditional independence between response variables while maintaining correlations between some of them. For instance, a Bayesian network may be utilized to model the data. The underlying structure of a Bayesian network may include a graph where each node represents a random variable and is connected to other nodes through conditional dependence (e.g., the outcome of one variable depends on one or more other variables). This graph structure may therefore be directed and by design may be acyclic when constructing the conditional dependencies. This structure allows for random variables to have local distributions by only considering the variables they are dependent on, known as parent variables.

For example, for two random variables X, Y in a joint probability space of possible outcomes, the chain rule of conditional probability may result in a probability distribution over X, Y, denoted by P(X, Y) where P(X|Y) is the conditional probability of Y given X. This rule can then be extended to a Bayesian network structure, known as the chain rule for Bayesian networks, where for any number of variables Xₙ for n=1,2,3 . . . the joint probability distribution can be written according to Equation 1:

P(X₁,X₂, . . . ,X_{N})=Πᵢ₌₁ⁿ(X₁|Parents(Xᵢ)) Equation 1:

where the right hand side of the equation is the multiplication of all the conditional probabilities from 1 to n in the graph for a potential outcome only considering the parents of each variable. When a variable has no parents, it is simply the marginal distribution P(X₁). This factorization of the joint probability distribution allows for the parameter space to reduce in size to at most n·2^{k} where n is the number of variables and k is the largest number of parents for a variable. Usually, variables only depend on a very small number of parents for their conditional probabilities, making the previous exponential parameter space linear in the variables. In addition to parameter reduction, Bayesian networks have several properties that are advantageous to modelling assessment data. First, due to the statistical nature of the model, they are explainable compared to other popular models that fit high dimensional data. Expert domain knowledge can also be included as prior distributions over the response variables. When performing inference, the model still produces predictions for the response variables even if there is missing data in the input.

The machine learning model 225 may be trained. For example, training a Bayesian network is a two step process: learning the structure of the dependencies, and fitting the parameters of the variables. There are several algorithms that may be applied to learn the structure of the network which may be categorized into at least three types: constraint-based, score-based, and hybrid algorithms. In some examples, the machine learning model 225 may be trained according to a score-based algorithm such as a hill-climbing (HC) algorithm. HC finds a local optimum by searching the possible orientations of edges connecting one variable to another and assigning a score to the potential structure. The Bayesian Information Criterion (BIC) may be used to score the structures, defined according to Equation 2:

BIC=p·ln(P(X|\hat{θ},M))

where p is the number of parameters in the model and n is the number of observations in the data. P(X|\hat{θ}, M may be referred to as the likelihood function, and may be the probability of observing the data X given the estimated parameter values θ and the model M, (e.g., the parameters that fit the data the best). The BIC score penalizes large amounts of parameters to the model while maximizing the likelihood function. Penalizing large parameters prevents the complexity of the model from getting too large which may result in overfitting the training data leading to poor performance on unseen data. The HC algorithm will iteratively search for a maximum BIC score until either the pre-defined maximum number of iterations is reached or increases to the score are no longer found. The learning model 225 may support independence equivalence, or I-equivalence. I-equivalence is the property that two structures with different directed edges still encode the conditional independencies of the underlying distribution given the data. Since two different graphs can encode the same conditional independencies of the variables, there is no indication that one is better than the other if the only thing different is the direction of the edges. One way to mitigate this is to define edges before starting the structure search. The learning model 225 may support techniques in which several of the input variables can be manually mapped to assessment controls in order to force dependencies between variables and reduce the search space for the structure.

Once the structure is found, the conditional dependencies between the variables are known and can be fitted with the parameters of the variables in the graph using the training data. The probabilities of the outcomes are stored in a Conditional Probability Distribution (CPD) table that captures the local distribution of a variable given its parents in a matrix of dimension defined by Equation 3:

|Xᵢ|×Πⱼ₌₁^{k}Parentⱼ(X₁)| for i=1,2,3 . . . Equation 3:

where | variable| denotes a number of outcomes, or cardinality, for the variable.

A probability distribution may be included over the outcomes of the variables to smooth out the bias in the assessment answers. The Bayesian Dirichlet equivalent uniform (BDeu) distribution may be used for two reasons: it makes computation of the distribution easier and it assumes a uniform distribution over the outcomes a priori. Before fitting a variable in the network with the data, the device may use a standard count for the prior distribution that is uniform across all outcomes of the CPD. The counts assigned to the outcomes are calculated from Equation 4:

$${α}_{i j} = \frac{q}{\vert X \vert \times {\prod }_{j = 1}^{k} {Parent}_{j} ( X ) \vert} \qquad Equation 4$$

where αᵢⱼ is the value set to the i^{th} and the j^{th} column entries of the CPD, q is the equivalent sample size hyperparameter, and the denominator in the equation is simply the number of entries the CPD table has. Since all the αᵢⱼ will be equivalent, this prior distribution is considered a uniform distribution across the CPD.

Since the Dirichlet prior is a conjugate prior, adjusting the probabilities is a relatively simple procedure. A conjugate prior is a distribution that will be the same distribution after including information from observations. To fit the probability of an outcome in the CPD using the data, the device may fix the outcome of the parents and add the normalized frequency of the variable's outcome to the αᵢⱼ. An example of a fitted CPD table may include conditional distributions that depend on the outcome of the parents.

The device may apply, at 225, the machine learning model. For example, the device may receive the one or more inputs (e.g., parameters), and the device (e.g., based on the learning model) may generate, by the one or more processors, multiple sets of candidate response inputs for the cyber security questionnaire based at least in part on a machine learning model and the one or more input parameter values. For example, to make predictions to the assessment answers given a company's input data, or evidence, the device may query the Bayesian network for inference on those variables. Several methods exist for generating outcomes on the response variables. These include exact inference methods to compute the joint probability given the structure of the graph, particle based methods that generate data points given the evidence, and maximum a posteriori (MAP) queries which return outcomes that maximize the probability of observing the evidence. Described techniques use particle based methods in the form of random sampling from the Bayesian network to produce more robust analysis on the potential assessment outcomes. Given enough samples, described techniques may approximate the true distribution. In particular, likelihood-weighted sampling may be used for the approximation.

Likelihood-weighted sampling (LW) provides the ability to fix the input variables and adjust the CPDs of the random variables in order to fit the event of observing the evidence. LW is a subset of a larger form of sampling called Importance Sampling where the topological ordering of the graph determines the order of importance to sample the variables. Sampling a variable consists of using the CPD column with the parent outcomes fixed to be the observations of the evidence and then drawing an outcome from that CPD with probabilities corresponding to those of the selected columns. The results of the sampled variables, being parents, in that order feed into the CPDs of the variables that depend on them, known as children, until the end of the ordering is reached. This process is then repeated for a predefined number of times to produce the same number of potential assessments.

The weighting strategy in LW stems from rejection sampling where the Bayesian network is sampled in the topological ordering without evidence. The samples would then be rejected if they did not match the evidence observations. This can become quite inefficient if the probability of observing the evidence is low. In LW, the weighting adjusts the significance of the sample to reflect the likelihood of the observed evidence's probability given its parents.

Having generated candidate questionnaire answers at 230, at 235 the device may determine, for each of the multiple sets of candidate response inputs for the cyber security questionnaire, a respective set of risk score values (e.g., may score the candidate response). At 240, the device may aggregate, by the one or more processors, each respective set of risk score values for each set of candidate response inputs for the cyber security questionnaire. At 245, the device may output, by the one or more processors for display to a user via a graphical user interface (GUI) on a user device, the set of predictive response outputs for the cyber security questionnaire. At 250, the device may calculate a set of confidence values for the set of predictive response outputs for the cyber security questionnaire.

In some examples, the device may analyze the candidate questionnaire at 255. The device may analyze, by the one or more processors, the multiple sets of candidate response inputs for the cyber security questionnaire, and identify, by the one or more processors, one or more high-risk security behaviors for the vendor based at least in part on the analyzed set of candidate response inputs. At 260, the device may calculate, by the one or more processors, a confidence value for the one or more high-risk security behaviors. The device may further output, by the one or more processors for display to the user via the graphical user interface on the user device, an indication of the one or more high-risk security behaviors, the confidence value for the one or more high-risk security behaviors, or both. Examples of such procedures are described in greater detail below.

In some examples, the process to produce coverage and maturity scores at the group level begins by iterating through each assessment in the sample block and scoring that possible assessment for each group. Once all the sampled assessments have been scored, a histogram per group is created with the scores. The histogram may support displaying the median as the expected value of the scores and a confidence around the expected value for the control coverage.

The maturity coverage may be displayed (e.g., via a GUI), as a range of scores: low, median, and high. Where the median is the expected value of the score, and the low and high scores cover a margin of error for the estimate.

Each sampled assessment produces a list of ranked gaps based on a data analysis. Each question is then scored by a point accumulation system based on its position in each list. The accumulation of these points over all lists is then used to rank or re-rank the union of all the gaps outputs in order to produce the top five across sampled assessments with an accompanying confidence score.

In order to process a company for results, the device may use a set of possible assessments to analyze given the observed predictor variables for that company. A sample size of 1000 may be chosen for LW since it may be both performative in time to completion as well as accuracy in approximation. It may take roughly 30 seconds to score and analyze a block of 1000 sampled assessments for a company. This computation is then distributed to run in parallel for multiple companies to obtain results.

In order to provide insights into a company's cyber security program, it is necessary to remain consistent with the already established metrics and summaries provided from self-assessed assessments (e.g., as stored in an exchange). When an entity completes an assessment, scores are generated from their answers to provide an overview of the level of risk in their cyber security program. These include coverage one or more control groups, maturity group coverage, and a gaps analysis to identify weaknesses. To estimate the true scores, the device may determine possible distribution of scores for a company by querying the possible assessments from the Bayesian network thus producing what may be referred to as a sample block.

Performance results for the model may be separated into coverage scoring results and the maturity scoring results. Although the coverage can have Not Applicable outcomes, the modelling problem is a multi-label problem. On the other hand, the modelling problem for the maturity is considered multi-class and multi-label. The outcomes range from 0-5 making it multi-class and there are 28 different maturity questions making it multi-label thus they may not be considered together.

Coverage predictions may be scored using the Mean Absolute Error (MAE) which describes the average distance of the errors from the actual scores. The device may calculate the MAE according to Equation 5:

$$M A E = \frac{1}{n} {\sum }_{i = 1}^{n} \vert {y}_{i} - {\hat{y}}_{i} \vert \qquad Equation 5$$

where n is the size of the test set, y is the true group score for an assessment and ŷ is the predicted score, and Σᵢ₌₁ⁿ|yᵢ-ŷᵢ|states the summation of all the distances in the samples from the true score. The | . . . | term in Equation 5 denotes taking the absolute value of the difference. This only considers how far an estimate is from the truth without having effects from the sign of that difference. The value after performing the summation may then be normalized using the size of the test set by multiplying 1/n.

Since each prediction of coverage is accompanied by a confidence level, the device may measure how often that confidence is correct in indicating whether or not the true score is captured within a threshold (e.g., a margin of error). For instance, a cutoff of 50% on the probability of capturing the true score within the margin of error may be used. This may be calculated using Equation 6:

$$Confidence Precision = \frac{1}{n} {\sum }_{i = 1}^{n} {1}_{\{ \vert {y}_{i} - {\hat{y}}_{i} \vert < ϵ : c \geq 0.5 \}} \qquad Equation 6$$

where ϵ is the proprietary margin of error for the estimate and c is the confidence that the estimate is contained within that margin. The term 1_{{|y}_{ᵢ}_{-ŷ}_{ᵢ}_{|≤ϵ:c≥0.5}} indicates to add 1 to the summation if the true score is within the margin of error and the confidence associated with capturing the true score is at least 50% and if otherwise to add 0.

Since predicting coverage is a binary multi-label classification problem, the device may use a Hamming Loss function to score the model for performance on accuracy. The Hamming Loss reflects the number of labels predicted wrong over the total number of labels. Since the Hamming Loss measures the mislabeling rate, a lower value for the Hamming loss is preferred over a higher one. The metric ranges in values between 0-1 and is calculated as follows according to Equation 7:

$$Hamming Loss = \frac{1}{\vert N \vert \cdot \vert L \vert} {\sum }_{i = 1}^{\vert N \vert} {\sum }_{i = 1}^{\vert L \vert} \{ {1}_{{y}_{i \neq j} {z}_{ij}} \} \qquad Equation 7$$

where |N| and |Z| are the number of samples and the number of labels to predict respectively. The values yᵢⱼzᵢⱼ are the true label and predicted label for the i^{th} assessment on the i^{th} control. The 1_{y}_{_{i≠j}}_{z}_{ᵢⱼ} indicates that the model will add 1 if a label is missed (e.g., y_{i≠j}zᵢⱼ) and 0 otherwise. The Hamming Loss may be calculated per group as well as over all groups.

For measuring the performance of the maturity question predictions, the MAE may be used to see how far the estimate may be from the true value as well as the true value being captured within the margin of error for each group. Note the maturity questions range between 0 and 5, instead of 0-100, which is why the MAE may be lower compared to the controls coverage.

Since residual risk is an output of the scoring, predicted overall residual risk may be measured compared to the true overall residual risk. The residual risk is a way to quantify the reduction in risk from having certain cyber security controls in place, thus reducing the inherent risk of the threat landscape to a company. The MAE may be used as a measure of how far an estimating the residual risk is from the true residual risk in a test set. The Confidence Precision may also used to see how often the true residual risk is captured within the margin of error. A Lower Bound Cutoff may also be utilized, which is a way to measure how often the true overall residual risk is kept above the predicted lower bound. This is important to note because the lower the overall residual risk, the less risk a company poses to their customer(s) and not keeping the true overall residual risk above a lower bound dilutes the validity of the prediction.

By design of the device, there may be a number (e.g., five) of predicted gaps outputs with an accompanying confidence level. The set of five predicted gaps can contain both high gaps and low gaps. Analytics from scoring an attested assessment can output zero or more gaps. For this reason the device measures the performance of the predicted gaps primarily through the intersection of the predicted set and the attested set. If the predicted set intersects at all with a non-empty attested set then that will contribute to the score. In an illustrative example, 43% of the time predicted gaps intersect with the attested gaps. Predicted high gaps, or gaps with a confidence of 40% or more, may intersect with the attested gaps 26% of the time.

Based on such modeling, the device may generate, for any entity (e.g., even vendors who have not filled out any questionnaire data), a predictive risk assessment. This may be accomplished by inputting parameters for the entity, and using the trained data set to determine a predictive set of answers to each question on a standardized questionnaire. The device described herein may further generate confidence scores for predictive risk assessments (e.g., for the range of candidate answers to each question, and then for a predicted output for each question), and an evaluation of a company's cyber security behavior, also with accompanying confidence scores.

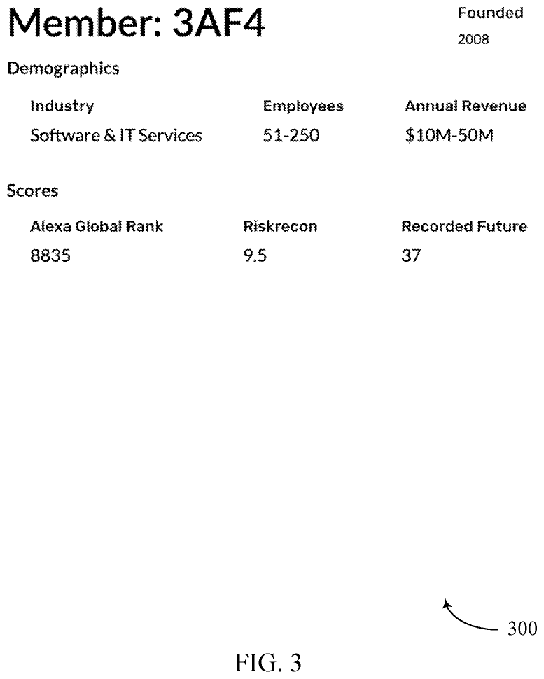

FIG. 3 illustrates an example of a security report 300 that supports predictive assessments of vendor risk in accordance with aspects of the present disclosure. may illustrate a GUI output of the system described herein via a user equipment, which may include a display, tab, screen shot, or dashboard view, among other examples. The security report 300 may include an indication of member information (e.g., for a given entity, such as a vendor 110).

Member information displays a summary of firmographic data used in all predictions. Industry is paramount in all predictions as it indicates the applicability and relevance of prevention, detection, and recovery measures. Founding date and employee count provide insight into the maturity and scalability of a program when considered in the context of its revenue and industrial sector. The included scores provide a signal of how existing infrastructure is currently configured compared to best practices.

Having a variety of quality data sources in predictive results may support the features described herein. However, any additional consideration of partner data inclusion may be based on highly selective criteria and may be considered (e.g., after extensive vetting).

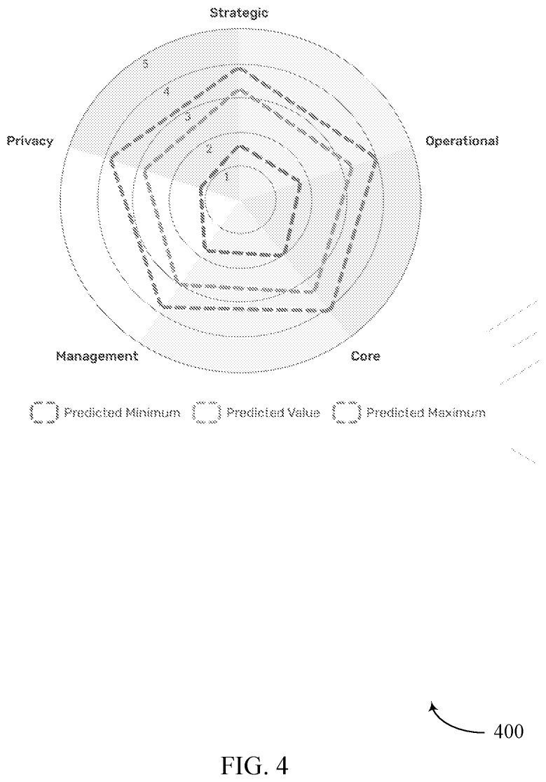

FIG. 4 illustrates an example of a security report 400 that supports predictive assessments of vendor risk in accordance with aspects of the present disclosure. The security report 400 may illustrate a GUI output of the system described herein via a user equipment, which may include a display, tab, screen shot, or dashboard view, among other examples. The security report 400 may include an indication of a predicted maturity (e.g., for a given entity, such as a vendor 110). Predicted Maturity is a prediction of the third party's responses to the capability maturity model section of the self-assessment questionnaire. The questions intend to measure the third party's people, process and technology across all control groups. The predicted value is shown in context of the most aggressive and conservative values.

Program Maturity is an indicator of the value an organization places on securing its infrastructure. An organization that does not invest in properly trained people, adequate processes, and reasonable sophisticated technology consistent with the measure of its service or product offering may not be able to maintain its control effectiveness for any period of time.

Maturity measures the overall development of an organization's cyber security posture. An organization with an immature cyber security program may have effective controls in place, but may lack experience or overall understanding of the program to use the controls well. maturity is a metric calculated using the described model (e.g., a capabilities maturity model) based on one or more input parameters, such as people, process, and technology, which may be comparable across all tiers, all entities, all vendors, etc. (e.g., may be standardized).

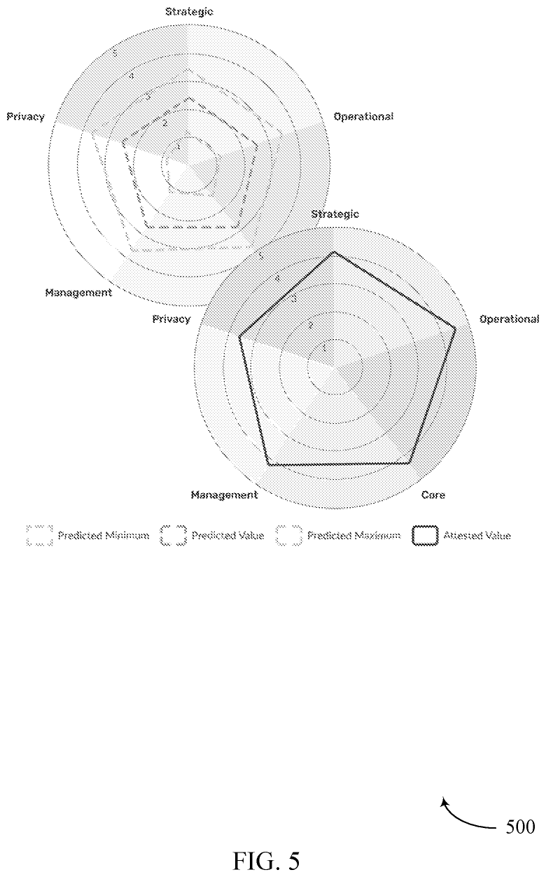

FIG. 5 illustrates an example of a security report 500 that supports predictive assessments of vendor risk in accordance with aspects of the present disclosure. The security report 500 may illustrate a GUI output of the system described herein via a user equipment, which may include a display, tab, screen shot, or dashboard view, among other examples. The security report 500 may include an indication of a maturity (e.g., for a given entity, such as a vendor 110). Maturity is a prediction of the third party's responses to the capability maturity model section of the self-assessment questionnaire. The questions intend to measure the third party's people, process and technology across all control groups. The predicted value is shown in context of the most aggressive and conservative values.

The attested view of the Maturity Prediction allows a comparative illustration of a predicted maturity score as well as the third party's attested program capability. In this example, the system predicted that the third party people, process and technology investments would achieve a defined maturity status: however, upon completion of the traditional self-assessment, this third party has slightly exceeded the predicted score.

Investment in people, process and technology related to security, collectively known as program maturity or Capability Maturity Model (CMM), provides an indication of the company's commitment to cyber security. Predicted Maturity provides a quick reference point in which to compare other predictions. If a company has strong controls but low maturity scores, it is unlikely that the third party will be able to maintain a good control hygiene for any significant amount of time. Specifically, being able to periodically compare predictions to a third party's attested maturity score may build a user's confidence in Predicted Maturity and Predicted Analytics.

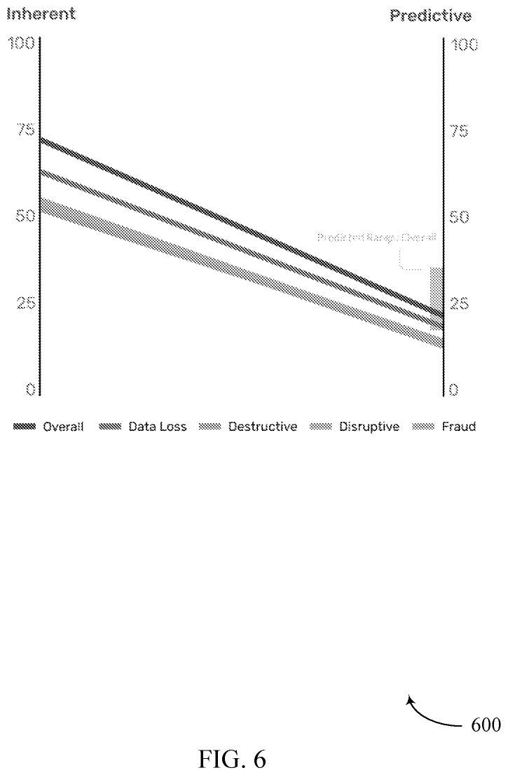

FIG. 6 illustrates an example of a security report 600 that supports predictive assessments of vendor risk in accordance with aspects of the present disclosure. The security report 600 may illustrate a GUI output of the system described herein via a user equipment, which may include a display, tab, screen shot, or dashboard view, among other examples. The security report 600 may include an indication of predicted risk surface score (e.g., for a given entity, such as a vendor 110).

A third party's risk posture is based on inherent risk (analysis of the likelihood of attacks along with the impact that could be conveyed to the customer by how they interact with that company), predictive risk (based on data analytics applied to the exchange database), an residual risk (confirmed through a self-assessment). The security report 600 may represent all three areas of risk for each of the four risk outcomes. In the absence of any assessments, security report 600 may display inherent risk and predictive risk (e.g., but not residual risk).

The described system's predictive capabilities may be based on a large exchange database including a large number (e.g., hundreds of thousands) of control assertions belonging to a taxonomy of many (e.g., millions) of firmographic profiles. Predicted Risk Surface indicates the third party's residual risk of a data loss, disruptive, destructive or fraud-related cyber events. All controls assessed in a self-assessment are associated to one or more of these four primary outcomes. Due to the enforcement of strict data-collection standards, the system may apply firmographic metadata to any one single Yes/No control assertion, resulting in effective prediction of the residual risk of a cyber event.

Cyber events, when sustained, are typically classified in terms of capital loss. If an entity plans to exchange sensitive data with an intended vendor and the Predicted Risk Surface for a data loss outcome is not substantially lower than its inherent origin, then the entity may rely on the indicated valuable foundation to either pursue additional diligence or defer for an alternative service provider. This prediction provides valuable efficiencies given the context in which an entity plans to interact with a given counterparty.

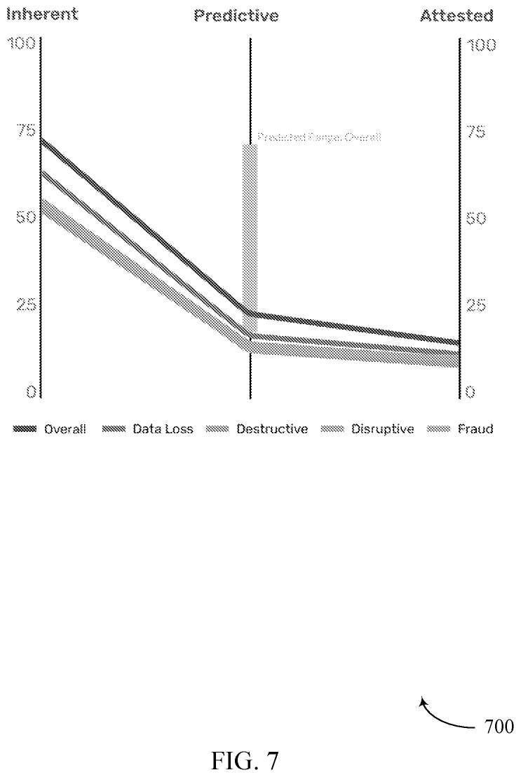

FIG. 7 illustrates an example of a security report 700 that supports predictive assessments of vendor risk in accordance with aspects of the present disclosure. The security report 700 may illustrate a GUI output of the system described herein via a user equipment, which may include a display, tab, screen shot, or dashboard view, among other examples. The security report 700 may include an indication of risk surface score (e.g., for a given entity, such as a vendor 110).

A third party view of the Predicted Risk Surface Score illustrates risk migration as it moves from inherent to predictive residual to attested residual risk. This view provides a single overall score which is indicated by the slid black line and is new. The additional lines provide the traditional outcomes of a cyber event (data loss, disruption, destruction, fraud).

The third party view of the Predicted Risk Surface Score is powerful evidence because it provides a visual basis of comparison for a user to begin to establish the use cases where it might be applicable given the margin of error ranges that are represented. In this example, the described system has predicted that the third party would retire 50 points of risk through the deployment of controls: however, once engaged through traditional self-assessment, even more risk is retired than the prediction.

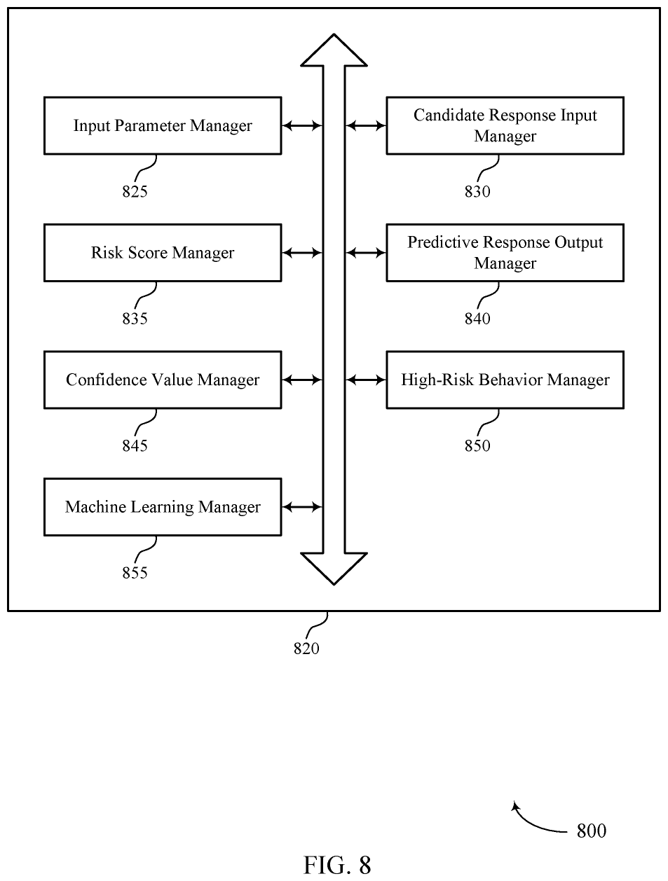

FIG. 8 shows a block diagram 800 of an action response component 820 that supports predictive assessments of vendor risk in accordance with aspects of the present disclosure. The action response component 820 may be an example of aspects of a system, device, or apparatus as described with reference to FIGS. 1 through 7. The action response component 820, or various components thereof, may be an example of means for performing various aspects of predictive assessments of vendor risk as described herein. For example, the action response component 820 may include an input parameter manager 825, a candidate response input manager 830), a risk score manager 835, a predictive response output manager 840, a confidence value manager 845, a high-risk behavior manager 850, a machine learning manager 855, or any combination thereof. Each of these components may communicate, directly or indirectly, with one another (e.g., via one or more buses).

The action response component 820 may support predictively assessing vendor risk in accordance with examples as disclosed herein. The input parameter manager 825 may be configured as or otherwise support a means for receiving, by one or more processors, one or more input parameter values for a cyber security questionnaire for a vendor, the one or more input parameter values comprising demographic data for the vendor, responsive input information for the cyber security questionnaire corresponding to at least a second vendor associated with the demographic data, rating information associated with the vendor, triggering event information associated with the vendor, or any combination thereof. The candidate response input manager 830 may be configured as or otherwise support a means for generating, by the one or more processors, multiple sets of candidate response inputs for the cyber security questionnaire based at least in part on a machine learning model and the one or more input parameter values. The risk score manager 835 may be configured as or otherwise support a means for determining, by the one or more processors for each of the multiple sets of candidate response inputs for the cyber security questionnaire, a respective set of risk score values. In some examples, the risk score manager 835 may be configured as or otherwise support a means for aggregating, by the one or more processors, each respective set of risk score values for each of the multiple sets of candidate response inputs for the cyber security questionnaire. The predictive response output manager 840) may be configured as or otherwise support a means for producing, by the one or more processors, a set of predictive response outputs for the cyber security questionnaire based on a distribution of the aggregated set of risk score values for each of the multiple sets of candidate response inputs for the cyber security questionnaire. In some examples, the predictive response output manager 840 may be configured as or otherwise support a means for outputting, by the one or more processors for display to a user via a graphical user interface on a user device, the set of predictive response outputs for the cyber security questionnaire.

In some examples, the confidence value manager 845 may be configured as or otherwise support a means for calculating a set of confidence values for the set of predictive response outputs for the cyber security questionnaire.

In some examples, the high-risk behavior manager 850 may be configured as or otherwise support a means for analyzing, by the one or more processors, the multiple sets of candidate response inputs for the cyber security questionnaire. In some examples, the high-risk behavior manager 850 may be configured as or otherwise support a means for identifying, by the one or more processors, one or more high-risk security behaviors for the vendor based at least in part on the analyzed set of candidate response inputs.

In some examples, the confidence value manager 845 may be configured as or otherwise support a means for calculating, by the one or more processors, a confidence value for the one or more high-risk security behaviors.

In some examples, the confidence value manager 845 may be configured as or otherwise support a means for outputting, by the one or more processors for display to the user via the graphical user interface on the user device, an indication of the one or more high-risk security behaviors, a confidence value for the one or more high-risk security behaviors, or both.

In some examples, the machine learning manager 855 may be configured as or otherwise support a means for generating, by the one or more processors, a set of questionnaire data for a plurality of vendors, the set of questionnaire data comprising response inputs for the cyber security questionnaire provided by the plurality of vendors. In some examples, the machine learning manager 855 may be configured as or otherwise support a means for training the machine learning model based at least in part on the set of questionnaire data, wherein generating the multiple sets of candidate response inputs is based at least in part on the training.

In some examples, to support training the machine learning model, the machine learning manager 855 may be configured as or otherwise support a means for generating, by the one or more processors, a set of preliminary predictive response outputs for the cyber security questionnaire for a first subset of vendors of a plurality of vendors based at least in part on the machine learning model and according a first set of weight values corresponding to a set of input parameter values associated with the first subset of vendors. In some examples, to support training the machine learning model, the machine learning manager 855 may be configured as or otherwise support a means for comparing, by the one or more processors, the set of preliminary predictive response outputs for the cyber security questionnaire for the first subset of vendors with at least a portion of the set of questionnaire data. In some examples, to support training the machine learning model, the machine learning manager 855 may be configured as or otherwise support a means for changing the first set of weight values to a second set of weight values based at least in part on the comparing.

In some examples, the machine learning manager 855 may be configured as or otherwise support a means for generating, by the one or more processors, a set of questionnaire data for a plurality of vendors, the set of questionnaire data comprising response inputs for the cyber security questionnaire provided by the plurality of vendors, wherein the one or more input parameter values are based at least in part on the set of questionnaire data. In some examples, the machine learning manager 855 may be configured as or otherwise support a means for adding the set of predictive response outputs for the cyber security questionnaire for the vendor to the set of questionnaire data.

In some examples, to support demographic data for the vendor, the candidate response input manager 830 may be configured as or otherwise support a means for a geographical location of the vendor, a number of employees associated with the vendor, revenue information associated with the vendor, a type of the vendor, or any combination thereof.

In some examples, to support triggering event information for the vendor, the candidate response input manager 830 may be configured as or otherwise support a means for a failure to comply with one or more security standard protocols, a data breach, a failure to provide responsive inputs to the cyber security questionnaire, or any combination thereof.

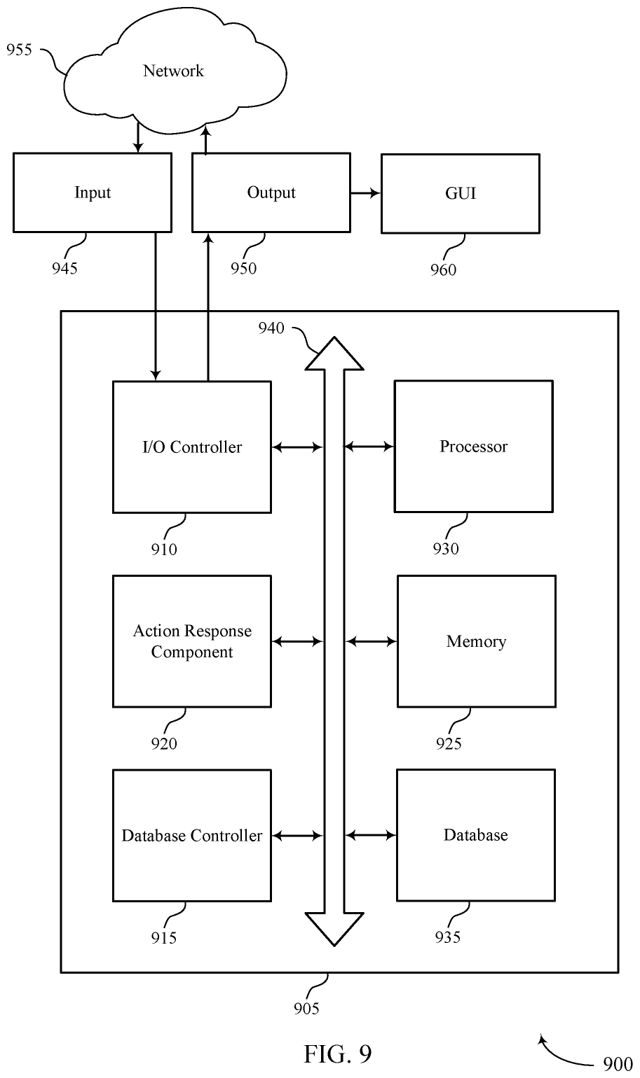

FIG. 9 shows a diagram of a system 900 including a device 905 that supports predictive assessments of vendor risk in accordance with aspects of the present disclosure. The device 905 may include components for bi-directional voice and data communications including components for transmitting and receiving communications, such as an action response component 920, an I/O controller 910, a database controller 915, a memory 925, a processor 930, and a database 935. These components may be in electronic communication or otherwise coupled (e.g., operatively, communicatively, functionally, electronically, electrically) via one or more buses (e.g., a bus 940).

The I/O controller 910 may manage inputs 945 and outputs 950 for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor. In some examples, a user may interact with the device 905 via the I/O controller 910 or via hardware components controlled by the I/O controller 910.

The database controller 915 may manage data storage and processing in a database 935. The database 935 may be external to the device 905, temporarily or permanently connected to the device 905, or a data storage component of the device 905. In some cases, a user may interact with the database controller 915. In some other cases, the database controller 915 may operate automatically without user interaction. The database 935 may be an example of a persistent data store, a single database, a distributed database, multiple distributed databases, a database management system, or an emergency backup database.

Memory 925 may include random-access memory (RAM) and ROM. The memory 925 may store computer-readable, computer-executable software including instructions that, when executed, cause the processor to perform various functions described herein. In some cases, the memory 925 may contain, among other things, a BIOS which may control basic hardware or software operation such as the interaction with peripheral components or devices.

The processor 930 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 930 may be configured to operate a memory array using a memory controller. In some other cases, a memory controller may be integrated into the processor 930. The processor 930 may be configured to execute computer-readable instructions stored in memory 925 to perform various functions (e.g., functions or tasks supporting predictive assessments of vendor risk).

The action response component 920 may support predictively assessing vendor risk in accordance with examples as disclosed herein. For example, the action response component 920 may be configured as or otherwise support a means for receiving, by one or more processors, one or more input parameter values for a cyber security questionnaire for a vendor, the one or more input parameter values comprising demographic data for the vendor, responsive input information for the cyber security questionnaire corresponding to at least a second vendor associated with the demographic data, rating information associated with the vendor, triggering event information associated with the vendor, or any combination thereof. The action response component 920 may be configured as or otherwise support a means for generating, by the one or more processors, multiple sets of candidate response inputs for the cyber security questionnaire based at least in part on a machine learning model and the one or more input parameter values. The action response component 920 may be configured as or otherwise support a means for determining, by the one or more processors for each of the multiple sets of candidate response inputs for the cyber security questionnaire, a respective set of risk score values. The action response component 920 may be configured as or otherwise support a means for aggregating, by the one or more processors, each respective set of risk score values for each of the multiple sets of candidate response inputs for the cyber security questionnaire. The action response component 920 may be configured as or otherwise support a means for producing, by the one or more processors, a set of predictive response outputs for the cyber security questionnaire based on a distribution of the aggregated set of risk score values for each of the multiple sets of candidate response inputs for the cyber security questionnaire. The action response component 920 may be configured as or otherwise support a means for outputting, by the one or more processors for display to a user via a graphical user interface on a user device, the set of predictive response outputs for the cyber security questionnaire.

The system 900 may also include a network 955, and a GUI 960. in some examples, the device 905 may receive inputs 945, such as one or more parameters from an exchange. In some examples, the device 905 may receive the inputs from, or via, a network 955 (e.g., the device 905 may access the inputs 945 via the network 955, or the inputs are provided by the exchange, which may be located on or provided by the network 955. In some examples, the device 905 may provide the outputs 950 (e.g., security reports, predicted security questionnaire responses, confidence scores, security behaviors, confidence scores, risk factors, etc.) via the GUI 960. In some examples, the system 900 may provide the outputs 950 on the GUI 960 via the network 955 (e.g., via a website, online dashboard, electronic communications, etc.).

By including or configuring the action response component 920 in accordance with examples as described herein, the device 905 may support techniques for predictive assessments of vendor risk, resulting in more accurate an consistent determination of vendor security behaviors, an ability to more accurately, and quickly, mitigate such security behaviors, an ability to determine or predict future security behaviors, and to more effectively select candidate vendors to maintain security by a business entity.

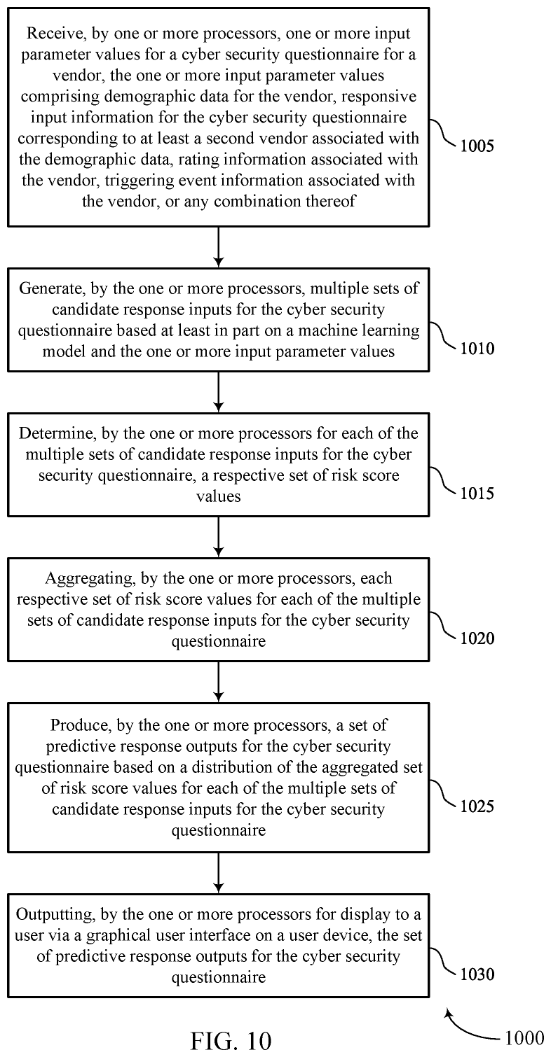

FIG. 10 shows a flowchart illustrating a method 1000 that supports predictive assessments of vendor risk in accordance with aspects of the present disclosure. The operations of the method 1000 may be implemented by an action response component or its components as described herein. For example, the operations of the method 1000 may be performed by an action response component as described with reference to FIGS. 1 through 9. In some examples, an action response component may execute a set of instructions to control the functional elements of the action response component to perform the described functions. Additionally, or alternatively, the action response component may perform aspects of the described functions using special-purpose hardware.

At 1005, the method may include receiving, by one or more processors, one or more input parameter values for a cyber security questionnaire for a vendor, the one or more input parameter values comprising demographic data for the vendor, responsive input information for the cyber security questionnaire corresponding to at least a second vendor associated with the demographic data, rating information associated with the vendor, triggering event information associated with the vendor, or any combination thereof. The operations of 1005 may be performed in accordance with examples as disclosed herein. In some examples, aspects of the operations of 1005 may be performed by an input parameter manager 825 as described with reference to FIG. 8.

At 1010, the method may include generating, by the one or more processors, multiple sets of candidate response inputs for the cyber security questionnaire based at least in part on a machine learning model and the one or more input parameter values. The operations of 1010 may be performed in accordance with examples as disclosed herein. In some examples, aspects of the operations of 1010 may be performed by a candidate response input manager 830 as described with reference to FIG. 8.

At 1015, the method may include determining, by the one or more processors for each of the multiple sets of candidate response inputs for the cyber security questionnaire, a respective set of risk score values. The operations of 1015 may be performed in accordance with examples as disclosed herein. In some examples, aspects of the operations of 1015 may be performed by a risk score manager 835 as described with reference to FIG. 8.

At 1020, the method may include aggregating, by the one or more processors, each respective set of risk score values for each of the multiple sets of candidate response inputs for the cyber security questionnaire. The operations of 1020 may be performed in accordance with examples as disclosed herein. In some examples, aspects of the operations of 1020 may be performed by a risk score manager 835 as described with reference to FIG. 8.

At 1025, the method may include producing, by the one or more processors, a set of predictive response outputs for the cyber security questionnaire based on a distribution of the aggregated set of risk score values for each of the multiple sets of candidate response inputs for the cyber security questionnaire. The operations of 1025 may be performed in accordance with examples as disclosed herein. In some examples, aspects of the operations of 1025 may be performed by a predictive response output manager 840 as described with reference to FIG. 8.

At 1030, the method may include outputting, by the one or more processors for display to a user via a graphical user interface on a user device, the set of predictive response outputs for the cyber security questionnaire. The operations of 1030 may be performed in accordance with examples as disclosed herein. In some examples, aspects of the operations of 1030 may be performed by a predictive response output manager 840 as described with reference to FIG. 8.

In some examples, an apparatus as described herein may perform a method or methods, such as the method 1000. The apparatus may include features, circuitry, logic, means, or instructions (e.g., a non-transitory computer-readable medium storing instructions executable by a processor) for receiving, by one or more processors, one or more input parameter values for a cyber security questionnaire for a vendor, the one or more input parameter values comprising demographic data for the vendor, responsive input information for the cyber security questionnaire corresponding to at least a second vendor associated with the demographic data, rating information associated with the vendor, triggering event information associated with the vendor, or any combination thereof, generating, by the one or more processors, multiple sets of candidate response inputs for the cyber security questionnaire based at least in part on a machine learning model and the one or more input parameter values, determining, by the one or more processors for each of the multiple sets of candidate response inputs for the cyber security questionnaire, a respective set of risk score values, aggregating, by the one or more processors, each respective set of risk score values for each of the multiple sets of candidate response inputs for the cyber security questionnaire, producing, by the one or more processors, a set of predictive response outputs for the cyber security questionnaire based on a distribution of the aggregated set of risk score values for each of the multiple sets of candidate response inputs for the cyber security questionnaire, and outputting, by the one or more processors for display to a user via a graphical user interface on a user device, the set of predictive response outputs for the cyber security questionnaire.

Some examples of the method 1000 and the apparatus described herein may further include operations, features, means, or instructions for calculating a set of confidence values for the set of predictive response outputs for the cyber security questionnaire.

Some examples of the method 1000 and the apparatus described herein may further include operations, features, means, or instructions for analyzing, by the one or more processors, the multiple sets of candidate response inputs for the cyber security questionnaire and identifying, by the one or more processors, one or more high-risk security behaviors for the vendor based at least in part on the analyzed set of candidate response inputs.

Some examples of the method 1000 and the apparatus described herein may further include operations, features, means, or instructions for calculating, by the one or more processors, a confidence value for the one or more high-risk security behaviors.

In some examples of the method 1000 and the apparatus described herein, outputting, by the one or more processors for display to the user via the graphical user interface on the user device, an indication of the one or more high-risk security behaviors, a confidence value for the one or more high-risk security behaviors, or both.

Some examples of the method 1000 and the apparatus described herein may further include operations, features, means, or instructions for generating, by the one or more processors, a set of questionnaire data for a plurality of vendors, the set of questionnaire data comprising response inputs for the cyber security questionnaire provided by the plurality of vendors and training the machine learning model based at least in part on the set of questionnaire data, wherein generating the multiple sets of candidate response inputs may be based at least in part on the training.

In some examples of the method 1000 and the apparatus described herein, training the machine learning model may include operations, features, circuitry, logic, means, or instructions for generating, by the one or more processors, a set of preliminary predictive response outputs for the cyber security questionnaire for a first subset of vendors of a plurality of vendors based at least in part on the machine learning model and according a first set of weight values corresponding to a set of input parameter values associated with the first subset of vendors, comparing, by the one or more processors, the set of preliminary predictive response outputs for the cyber security questionnaire for the first subset of vendors with at least a portion of the set of questionnaire data, and changing the first set of weight values to a second set of weight values based at least in part on the comparing.

Some examples of the method 1000 and the apparatus described herein may further include operations, features, means, or instructions for generating, by the one or more processors, a set of questionnaire data for a plurality of vendors, the set of questionnaire data comprising response inputs for the cyber security questionnaire provided by the plurality of vendors, wherein the one or more input parameter values may be based at least in part on the set of questionnaire data and adding the set of predictive response outputs for the cyber security questionnaire for the vendor to the set of questionnaire data.

In some examples of the method 1000 and the apparatus described herein, the demographic data for the vendor may include operations, features, circuitry, logic, means, or instructions for a geographical location of the vendor, a number of employees associated with the vendor, revenue information associated with the vendor, a type of the vendor, or any combination thereof.

In some examples of the method 1000 and the apparatus described herein, the triggering event information for the vendor may include operations, features, circuitry, logic, means, or instructions for a failure to comply with one or more security standard protocols, a data breach, a failure to provide responsive inputs to the cyber security questionnaire, or any combination thereof.

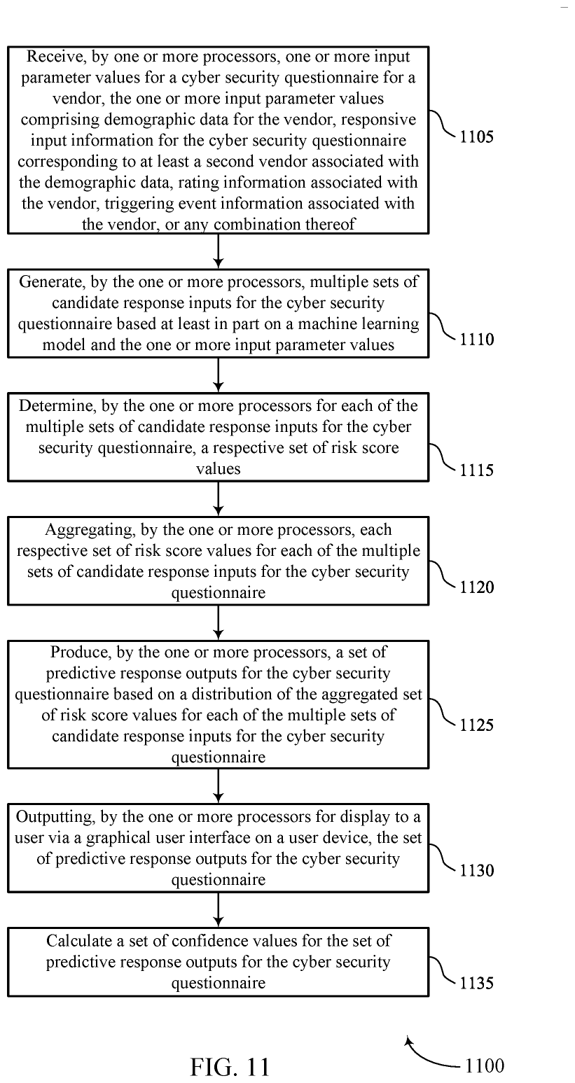

FIG. 11 shows a flowchart illustrating a method 1100 that supports predictive assessments of vendor risk in accordance with aspects of the present disclosure. The operations of the method 1100 may be implemented by an action response component or its components as described herein. For example, the operations of the method 1100 may be performed by an action response component as described with reference to FIGS. 1 through 9. In some examples, an action response component may execute a set of instructions to control the functional elements of the action response component to perform the described functions. Additionally, or alternatively, the action response component may perform aspects of the described functions using special-purpose hardware.

At 1105, the method may include receiving, by one or more processors, one or more input parameter values for a cyber security questionnaire for a vendor, the one or more input parameter values comprising demographic data for the vendor, responsive input information for the cyber security questionnaire corresponding to at least a second vendor associated with the demographic data, rating information associated with the vendor, triggering event information associated with the vendor, or any combination thereof. The operations of 1105 may be performed in accordance with examples as disclosed herein. In some examples, aspects of the operations of 1105 may be performed by an input parameter manager 825 as described with reference to FIG. 8.

At 1110, the method may include generating, by the one or more processors, multiple sets of candidate response inputs for the cyber security questionnaire based at least in part on a machine learning model and the one or more input parameter values. The operations of 1110 may be performed in accordance with examples as disclosed herein. In some examples, aspects of the operations of 1110 may be performed by a candidate response input manager 830) as described with reference to FIG. 8.

At 1115, the method may include determining, by the one or more processors for each of the multiple sets of candidate response inputs for the cyber security questionnaire, a respective set of risk score values. The operations of 1115 may be performed in accordance with examples as disclosed herein. In some examples, aspects of the operations of 1115 may be performed by a risk score manager 835 as described with reference to FIG. 8.

At 1120, the method may include aggregating, by the one or more processors, each respective set of risk score values for each of the multiple sets of candidate response inputs for the cyber security questionnaire. The operations of 1120 may be performed in accordance with examples as disclosed herein. In some examples, aspects of the operations of 1120 may be performed by a risk score manager 835 as described with reference to FIG. 8.

At 1125, the method may include producing, by the one or more processors, a set of predictive response outputs for the cyber security questionnaire based on a distribution of the aggregated set of risk score values for each of the multiple sets of candidate response inputs for the cyber security questionnaire. The operations of 1125 may be performed in accordance with examples as disclosed herein. In some examples, aspects of the operations of 1125 may be performed by a predictive response output manager 840 as described with reference to FIG. 8.

At 1130, the method may include outputting, by the one or more processors for display to a user via a graphical user interface on a user device, the set of predictive response outputs for the cyber security questionnaire. The operations of 1130 may be performed in accordance with examples as disclosed herein. In some examples, aspects of the operations of 1130 may be performed by a predictive response output manager 840 as described with reference to FIG. 8.

At 1135, the method may include calculating a set of confidence values for the set of predictive response outputs for the cyber security questionnaire. The operations of 1135 may be performed in accordance with examples as disclosed herein. In some examples, aspects of the operations of 1135 may be performed by a confidence value manager 845 as described with reference to FIG. 8.

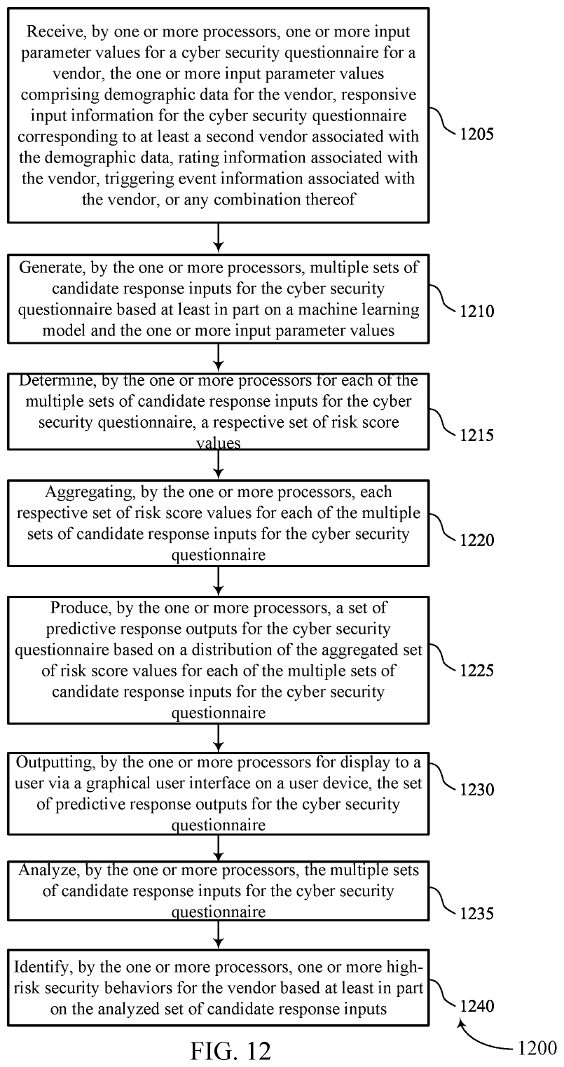

FIG. 12 shows a flowchart illustrating a method 1200 that supports predictive assessments of vendor risk in accordance with aspects of the present disclosure. The operations of the method 1200 may be implemented by an action response component or its components as described herein. For example, the operations of the method 1200 may be performed by an action response component as described with reference to FIGS. 1 through 9. In some examples, an action response component may execute a set of instructions to control the functional elements of the action response component to perform the described functions. Additionally, or alternatively, the action response component may perform aspects of the described functions using special-purpose hardware.

At 1205, the method may include receiving, by one or more processors, one or more input parameter values for a cyber security questionnaire for a vendor, the one or more input parameter values comprising demographic data for the vendor, responsive input information for the cyber security questionnaire corresponding to at least a second vendor associated with the demographic data, rating information associated with the vendor, triggering event information associated with the vendor, or any combination thereof. The operations of 1205 may be performed in accordance with examples as disclosed herein. In some examples, aspects of the operations of 1205 may be performed by an input parameter manager 825 as described with reference to FIG. 8.

At 1210, the method may include generating, by the one or more processors, multiple sets of candidate response inputs for the cyber security questionnaire based at least in part on a machine learning model and the one or more input parameter values. The operations of 1210 may be performed in accordance with examples as disclosed herein. In some examples, aspects of the operations of 1210 may be performed by a candidate response input manager 830 as described with reference to FIG. 8.

At 1215, the method may include determining, by the one or more processors for each of the multiple sets of candidate response inputs for the cyber security questionnaire, a respective set of risk score values. The operations of 1215 may be performed in accordance with examples as disclosed herein. In some examples, aspects of the operations of 1215 may be performed by a risk score manager 835 as described with reference to FIG. 8.

At 1220, the method may include aggregating, by the one or more processors, each respective set of risk score values for each of the multiple sets of candidate response inputs for the cyber security questionnaire. The operations of 1220 may be performed in accordance with examples as disclosed herein. In some examples, aspects of the operations of 1220 may be performed by a risk score manager 835 as described with reference to FIG. 8.

At 1225, the method may include producing, by the one or more processors, a set of predictive response outputs for the cyber security questionnaire based on a distribution of the aggregated set of risk score values for each of the multiple sets of candidate response inputs for the cyber security questionnaire. The operations of 1225 may be performed in accordance with examples as disclosed herein. In some examples, aspects of the operations of 1225 may be performed by a predictive response output manager 840 as described with reference to FIG. 8.

At 1230, the method may include outputting, by the one or more processors for display to a user via a graphical user interface on a user device, the set of predictive response outputs for the cyber security questionnaire. The operations of 1230 may be performed in accordance with examples as disclosed herein. In some examples, aspects of the operations of 1230 may be performed by a predictive response output manager 840 as described with reference to FIG. 8.

At 1235, the method may include analyzing, by the one or more processors, the multiple sets of candidate response inputs for the cyber security questionnaire. The operations of 1235 may be performed in accordance with examples as disclosed herein. In some examples, aspects of the operations of 1235 may be performed by a high-risk behavior manager 850 as described with reference to FIG. 8.

At 1240, the method may include identifying, by the one or more processors, one or more high-risk security behaviors for the vendor based at least in part on the analyzed set of candidate response inputs. The operations of 1240 may be performed in accordance with examples as disclosed herein. In some examples, aspects of the operations of 1240 may be performed by a high-risk behavior manager 850 as described with reference to FIG. 8.

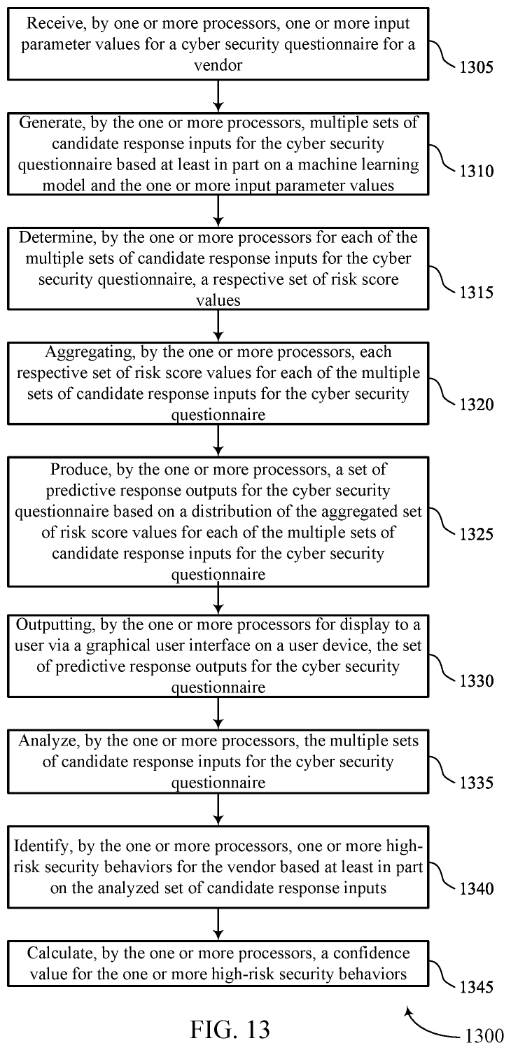

FIG. 13 shows a flowchart illustrating a method 1300 that supports predictive assessments of vendor risk in accordance with aspects of the present disclosure. The operations of the method 1300 may be implemented by an action response component or its components as described herein. For example, the operations of the method 1300 may be performed by an action response component as described with reference to FIGS. 1 through 9. In some examples, an action response component may execute a set of instructions to control the functional elements of the action response component to perform the described functions. Additionally, or alternatively, the action response component may perform aspects of the described functions using special-purpose hardware.

At 1305, the method may include receiving, by one or more processors, one or more input parameter values for a cyber security questionnaire for a vendor, the one or more input parameter values comprising demographic data for the vendor, responsive input information for the cyber security questionnaire corresponding to at least a second vendor associated with the demographic data, rating information associated with the vendor, triggering event information associated with the vendor, or any combination thereof. The operations of 1305 may be performed in accordance with examples as disclosed herein. In some examples, aspects of the operations of 1305 may be performed by an input parameter manager 825 as described with reference to FIG. 8.

At 1310, the method may include generating, by the one or more processors, multiple sets of candidate response inputs for the cyber security questionnaire based at least in part on a machine learning model and the one or more input parameter values. The operations of 1310 may be performed in accordance with examples as disclosed herein. In some examples, aspects of the operations of 1310 may be performed by a candidate response input manager 830 as described with reference to FIG. 8.

At 1315, the method may include determining, by the one or more processors for each of the multiple sets of candidate response inputs for the cyber security questionnaire, a respective set of risk score values. The operations of 1315 may be performed in accordance with examples as disclosed herein. In some examples, aspects of the operations of 1315 may be performed by a risk score manager 835 as described with reference to FIG. 8.

At 1320, the method may include aggregating, by the one or more processors, each respective set of risk score values for each of the multiple sets of candidate response inputs for the cyber security questionnaire. The operations of 1320 may be performed in accordance with examples as disclosed herein. In some examples, aspects of the operations of 1320 may be performed by a risk score manager 835 as described with reference to FIG. 8.

At 1325, the method may include producing, by the one or more processors, a set of predictive response outputs for the cyber security questionnaire based on a distribution of the aggregated set of risk score values for each of the multiple sets of candidate response inputs for the cyber security questionnaire. The operations of 1325 may be performed in accordance with examples as disclosed herein. In some examples, aspects of the operations of 1325 may be performed by a predictive response output manager 840 as described with reference to FIG. 8.

At 1330, the method may include outputting, by the one or more processors for display to a user via a graphical user interface on a user device, the set of predictive response outputs for the cyber security questionnaire. The operations of 1330 may be performed in accordance with examples as disclosed herein. In some examples, aspects of the operations of 1330 may be performed by a predictive response output manager 840 as described with reference to FIG. 8.

At 1335, the method may include analyzing, by the one or more processors, the multiple sets of candidate response inputs for the cyber security questionnaire. The operations of 1335 may be performed in accordance with examples as disclosed herein. In some examples, aspects of the operations of 1335 may be performed by a high-risk behavior manager 850 as described with reference to FIG. 8.

At 1340, the method may include identifying, by the one or more processors, one or more high-risk security behaviors for the vendor based at least in part on the analyzed set of candidate response inputs. The operations of 1340 may be performed in accordance with examples as disclosed herein. In some examples, aspects of the operations of 1340 may be performed by a high-risk behavior manager 850 as described with reference to FIG. 8.

At 1345, the method may include calculating, by the one or more processors, a confidence value for the one or more high-risk security behaviors. The operations of 1345 may be performed in accordance with examples as disclosed herein. In some examples, aspects of the operations of 1345 may be performed by a confidence value manager 845 as described with reference to FIG. 8.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for consumer preference and maintenance interface.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, an field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A non-transitory computer-readable medium storing code for predictively assessing vendor risk, the code comprising instructions executable by a processor to:
receive, by one or more processors, one or more input parameter values for a cyber security questionnaire for a vendor, the one or more input parameter values comprising demographic data for the vendor, responsive input information for the cyber security questionnaire corresponding to at least a second vendor associated with the demographic data, rating information associated with the vendor, triggering event information associated with the vendor, or any combination thereof;
generate, by the one or more processors, multiple sets of candidate response inputs for the cyber security questionnaire based at least in part on a machine learning model and the one or more input parameter values;
determine, by the one or more processors for each of the multiple sets of candidate response inputs for the cyber security questionnaire, a respective set of risk score values;
aggregate, by the one or more processors, each respective set of risk score values for each of the multiple sets of candidate response inputs for the cyber security questionnaire;
produce, by the one or more processors, a set of predictive response outputs for the cyber security questionnaire based on a distribution of the aggregated set of risk score values for each of the multiple sets of candidate response inputs for the cyber security questionnaire; and
output, by the one or more processors for display to a user via a graphical user interface on a user device, the set of predictive response outputs for the cyber security questionnaire.

2. The non-transitory computer-readable medium of claim 1, wherein the instructions are further executable by the processor to:
calculate a set of confidence values for the set of predictive response outputs for the cyber security questionnaire.

3. The non-transitory computer-readable medium of claim 1, wherein the instructions are further executable by the processor to:
analyze, by the one or more processors, the multiple sets of candidate response inputs for the cyber security questionnaire; and
identify, by the one or more processors, one or more high-risk security behaviors for the vendor based at least in part on the analyzed set of candidate response inputs.

4. The non-transitory computer-readable medium of claim 3, wherein the instructions are further executable by the processor to:
calculate, by the one or more processors, a confidence value for the one or more high-risk security behaviors.

5. The non-transitory computer-readable medium of claim 3, wherein the instructions are further executable by the processor to:
output, by the one or more processors for display to the user via the graphical user interface on the user device, an indication of the one or more high-risk security behaviors, a confidence value for the one or more high-risk security behaviors, or both.

6. The non-transitory computer-readable medium of claim 1, wherein the instructions are further executable by the processor to:
generate, by the one or more processors, a set of questionnaire data for a plurality of vendors, the set of questionnaire data comprising response inputs for the cyber security questionnaire provided by the plurality of vendors; and
train the machine learning model based at least in part on the set of questionnaire data, wherein generating the multiple sets of candidate response inputs is based at least in part on the training.

7. The non-transitory computer-readable medium of claim 6, wherein the instructions to train the machine learning model are further executable by the processor to:
generate, by the one or more processors, a set of preliminary predictive response outputs for the cyber security questionnaire for a first subset of vendors of a plurality of vendors based at least in part on the machine learning model and according a first set of weight values corresponding to a set of input parameter values associated with the first subset of vendors;
compare, by the one or more processors, the set of preliminary predictive response outputs for the cyber security questionnaire for the first subset of vendors with at least a portion of the set of questionnaire data; and
change the first set of weight values to a second set of weight values based at least in part on the comparing.

8. The non-transitory computer-readable medium of claim 1, wherein the instructions are further executable by the processor to:
generate, by the one or more processors, a set of questionnaire data for a plurality of vendors, the set of questionnaire data comprising response inputs for the cyber security questionnaire provided by the plurality of vendors, wherein the one or more input parameter values are based at least in part on the set of questionnaire data; and
add the set of predictive response outputs for the cyber security questionnaire for the vendor to the set of questionnaire data.

9. The non-transitory computer-readable medium of claim 1, wherein the instructions to demographic data for the vendor are executable by the processor to:
a geographical location of the vendor, a number of employees associate with the vendor, revenue information associated with the vendor, a type of the vendor, or any combination thereof.

10. The non-transitory computer-readable medium of claim 1, wherein the instructions to trigger event information for the vendor are executable by the processor to:
a failure to comply with one or more security standard protocols, a data breach, a failure to provide responsive inputs to the cyber security questionnaire, or any combination thereof.

11. An apparatus for predictively assessing vendor risk, comprising:
a processor;
memory coupled with the processor; and
instructions stored in the memory and executable by the processor to cause the apparatus to:
receive, by one or more processors, one or more input parameter values for a cyber security questionnaire for a vendor, the one or more input parameter values comprising demographic data for the vendor, responsive input information for the cyber security questionnaire corresponding to at least a second vendor associated with the demographic data, rating information associated with the vendor, triggering event information associated with the vendor, or any combination thereof;
generate, by the one or more processors, multiple sets of candidate response inputs for the cyber security questionnaire based at least in part on a machine learning model and the one or more input parameter values;
determine, by the one or more processors for each of the multiple sets of candidate response inputs for the cyber security questionnaire, a respective set of risk score values;
aggregate, by the one or more processors, each respective set of risk score values for each of the multiple sets of candidate response inputs for the cyber security questionnaire;
produce, by the one or more processors, a set of predictive response outputs for the cyber security questionnaire based on a distribution of the aggregated set of risk score values for each of the multiple sets of candidate response inputs for the cyber security questionnaire; and
output, by the one or more processors for display to a user via a graphical user interface on a user device, the set of predictive response outputs for the cyber security questionnaire.

12. The apparatus of claim 11, wherein the instructions are further executable by the processor to cause the apparatus to:
calculate a set of confidence values for the set of predictive response outputs for the cyber security questionnaire.

13. The apparatus of claim 11, wherein the instructions are further executable by the processor to cause the apparatus to:
analyze, by the one or more processors, the multiple sets of candidate response inputs for the cyber security questionnaire; and
identify, by the one or more processors, one or more high-risk security behaviors for the vendor based at least in part on the analyzed set of candidate response inputs.

14. The apparatus of claim 13, wherein the instructions are further executable by the processor to cause the apparatus to:
calculate, by the one or more processors, a confidence value for the one or more high-risk security behaviors.

15. The apparatus of claim 13, wherein the instructions are further executable by the processor to cause the apparatus to:
output, by the one or more processors for display to the user via the graphical user interface on the user device, an indication of the one or more high-risk security behaviors, a confidence value for the one or more high-risk security behaviors, or both.

16. The apparatus of claim 11, wherein the instructions are further executable by the processor to cause the apparatus to:
generate, by the one or more processors, a set of questionnaire data for a plurality of vendors, the set of questionnaire data comprising response inputs for the cyber security questionnaire provided by the plurality of vendors; and
train the machine learning model based at least in part on the set of questionnaire data, wherein generating the multiple sets of candidate response inputs is based at least in part on the training.

17. The apparatus of claim 16, wherein the instructions to train the machine learning model are further executable by the processor to cause the apparatus to:
generate, by the one or more processors, a set of preliminary predictive response outputs for the cyber security questionnaire for a first subset of vendors of a plurality of vendors based at least in part on the machine learning model and according a first set of weight values corresponding to a set of input parameter values associated with the first subset of vendors;
compare, by the one or more processors, the set of preliminary predictive response outputs for the cyber security questionnaire for the first subset of vendors with at least a portion of the set of questionnaire data; and
change the first set of weight values to a second set of weight values based at least in part on the comparing.

18. The apparatus of claim 11, wherein the instructions are further executable by the processor to cause the apparatus to:
generate, by the one or more processors, a set of questionnaire data for a plurality of vendors, the set of questionnaire data comprising response inputs for the cyber security questionnaire provided by the plurality of vendors, wherein the one or more input parameter values are based at least in part on the set of questionnaire data; and
add the set of predictive response outputs for the cyber security questionnaire for the vendor to the set of questionnaire data.

19. The apparatus of claim 11, wherein the instructions to demographic data for the vendor are executable by the processor to cause the apparatus to:
a geographical location of the vendor, a number of employees associate with the vendor, revenue information associated with the vendor, a type of the vendor, or any combination thereof.

20. The apparatus of claim 11, wherein the instructions to trigger event information for the vendor are executable by the processor to cause the apparatus to:
a failure to comply with one or more security standard protocols, a data breach, a failure to provide responsive inputs to the cyber security questionnaire, or any combination thereof.
